(19) United States
(12) Patent Application Publication
(10) Pub. No.: US 2006/0015245 A1
(43) Pub. Date: Jan. 19, 2006

(54) Method for remote synchronisation of a traffic monitoring system

(75) Inventor: Theodorus Maria Janssen, Spaarndam (NL)

Correspondence Address: DORSEY & WHITNEY LLP, 555 CALIFORNIA STREET, SUITE 1000, SUITE 1000, SAN FRANCISCO, CA, 94104, US

(73) Assignee: Gatsometer B.V.

(21) Appl. No.: 10/511,477

(22) PCT Filed: Apr. 15, 2003
(86) PCT No.: PCT/NL03/00287

§ 371 Date: Aug. 12, 2005

(30) Foreign Application Priority Data
Apr. 15, 2002 (NL) 1020387

(51) Int. Cl. G06F 19/00

(52) U.S. Cl. 701/117; 340/913

(57) ABSTRACT

This invention relates to a method for synchronizing a clock of a traffic monitoring system, by periodically transmitting a synchronization signal to the system from a satellite, which signal forms an indication of the exact time, comparing the time indicated by the clock with the signal, and adjusting the time indicated by the clock if this differs from the synchronization signal. The satellite can be a navigation satellite, whereby the location of the system can also be determined from the received synchronization signal. The time or the operation of the traffic monitoring system can for instance be adjusted on the basis of the location.

The invention relates to a method for synchronizing a clock of a traffic monitoring system, comprising of periodically transmitting a synchronization signal to the traffic monitoring system from a remote location, which signal forms an indication of the exact time, comparing the time indicated by the clock with the synchronization signal, and adjusting the time indicated by the clock if this differs from the synchronization signal. Such a method is known and is applied for synchronization of a red-light camera in Rugby (GB) manufactured by applicant.

In traffic monitoring systems provided with a clock it is of great importance that it precisely indicates the correct time. This is particularly the case for traffic monitoring systems which are intended for the purpose of detecting and recording traffic violations, such as red-light cameras or speed cameras. In such systems the place and time of the detected offence are usually also recorded, which is necessary in order to give the record the status of legal and conclusive proof of the offence. When use is for instance made of an optical camera to record the offence, the place and time can be projected in the image. If recording takes place by means of a digital camera, these data can also be linked to the data file which shows the recorded image in digital form. Errors or lack of clarity in the recording of the place and time of the offence can have the result that prosecution of the offender becomes impossible.

In the known method the traffic monitoring system, or red-light camera, is provided with a radio receiver which is connected to the internal clock of the system. This radio receiver is tuned to a transmitter which transmits a synchronization signal based on a very precise time measurement, for instance using an atomic clock. At this moment there are various institutions which have atomic clocks available and which make such synchronization signals available for transmission, inter alia in Germany (DCF77), Switzerland (HGB) and Great Britain (MSF). These synchronization signals are generally transmitted via the short or long wave, so that they can be received in a wide area.

In the known method use is made of the British signal, which corresponds directly with the local time at the location of the red-light camera. The time which is indicated by the internal clock of the red-light camera is periodically compared to the time signal received by the radio receiver and, if there is found to be a difference, the internal clock is reset. Thus is ensured that the internal clock always indicates the correct time and there can therefore be no uncertainty about the time of a recorded violation.

The known method does however have the drawback that the reception of radio signals can be disturbed by atmospheric conditions or other causes. If the reception is disrupted for a long period, or in any case during a number of synchronization moments, there is the danger of the internal clock not being adjusted for a longer period, whereby doubt may arise as to the correctness of the time displayed on a record of an offence.

The invention now has for its object to provide a method of the above described type wherein this drawback does not occur. According to the invention this is achieved with such a method in that the synchronization signal is transmitted from a satellite. By transmitting the synchronization signal in this manner the danger of disruption is considerably smaller. Furthermore, traffic monitoring systems can thus be synchronized at far removed locations.

The satellite is herein preferably a navigation satellite and the location of the system is also determined from the received synchronization signal. This information is particularly important in the case of mobile traffic monitoring systems such as speed cameras or other control equipment fitted in patrol cars or disposed along the side of a road.

The time derived from the received synchronization signal can advantageously then be adjusted to the location determined on the basis of the synchronization signal. A correct time indication is thus ensured in the system under all conditions, wherein for instance summer and winter time can also be taken into account automatically.

According to a preferably applied variant of the method according to the invention, the operation of the traffic monitoring system is controlled on the basis of the time and/or location derived from the synchronization signal. When the system is adapted to detect speeding offences, a different maximum speed for instance can thus be applied during rush hours than at quiet moments. In the case of a mobile system the speed at which a recording is made can also be automatically adjusted to the maximum speed at the location of the system.

The operation of the system can herein be adjusted on the basis of a program stored in the system, but it is also possible for a control signal to be transmitted to the traffic monitoring system along with the synchronization signal.

The invention also relates to a system for monitoring traffic, wherein the above described method can be applied. Use can be made herein of a known traffic monitoring system, such as the above described red-light camera of applicant, which is provided with means for monitoring a traffic situation, at least one clock connected to the monitoring means and means connected to the at least one clock for synchronizing thereof, which synchronizing means are adapted to receive a synchronization signal, to compare the time indicated by the clock with the synchronization signal and to adjust the time indicated by the clock if this differs from the synchronization signal. This system now has the feature according to the invention that the synchronizing means are adapted to receive the synchronization signal from a satellite.

When the satellite is a navigation satellite, the synchronizing means are preferably adapted to determine the location of the system from the received synchronization signal.

The synchronizing means can advantageously be adapted herein to adjust the time derived from the received synchronization signal to the location determined on the basis of the synchronization signal.

The traffic monitoring system is preferably further provided with control means which are connected to the synchronizing means and which are adapted to control the operation of the traffic monitoring system on the basis of the time and/or location derived from the synchronization signal.

The control means can execute a previously inputted program, although the synchronizing means can also be adapted to receive and pass on to the control means a control signal transmitted together with the synchronization signal.

When the monitoring means are adapted to record the monitored traffic situation on the basis of a recording signal which is generated by the control means on the basis of a criterion, the control means are preferably adapted to adjust the criterion to the time and/or location, optionally on the basis of the control signal transmitted together with the synchronization signal.

The invention is elucidated hereinbelow on the basis of two embodiments, wherein reference is made to the annexed drawing, in which:

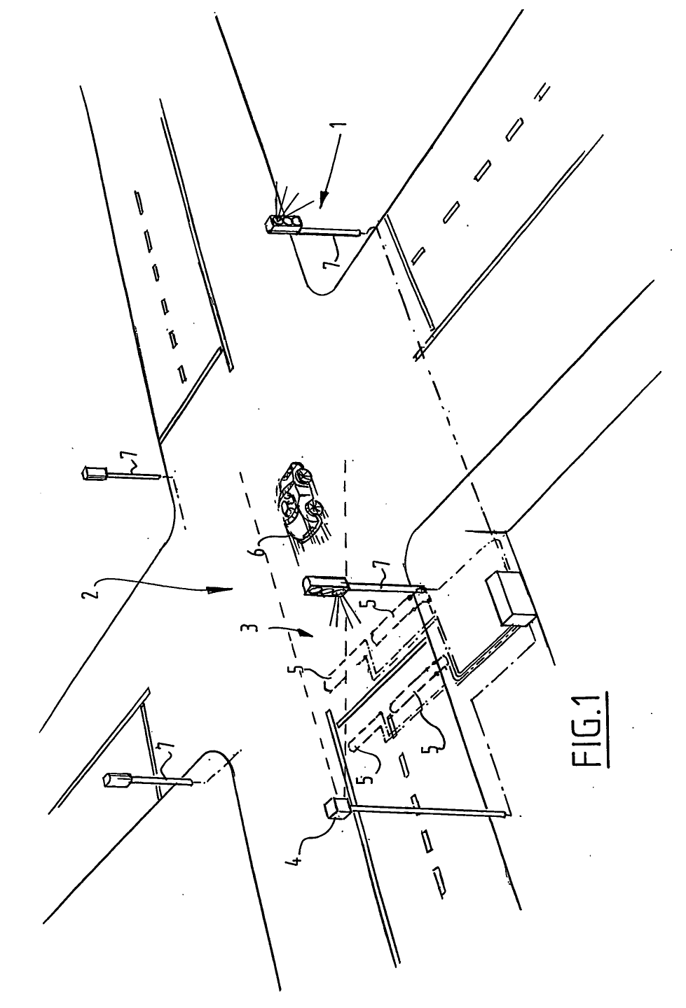

FIG. 1 is a perspective view of a first embodiment of the traffic monitoring system according to the invention,

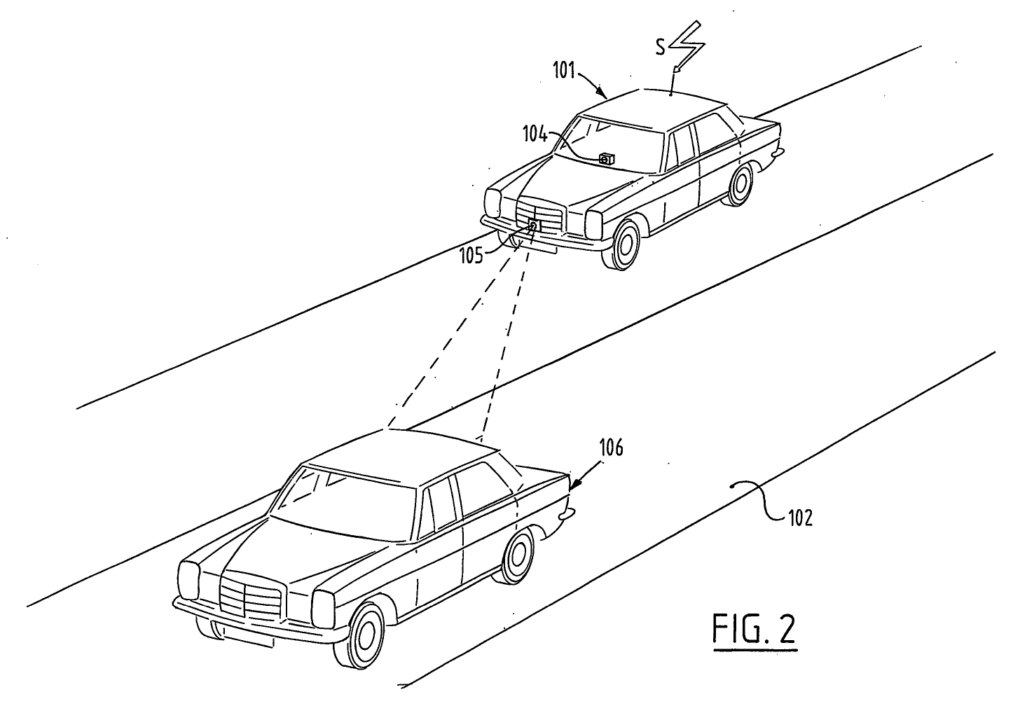

FIG. 2 is a perspective view of a second embodiment of the system, and

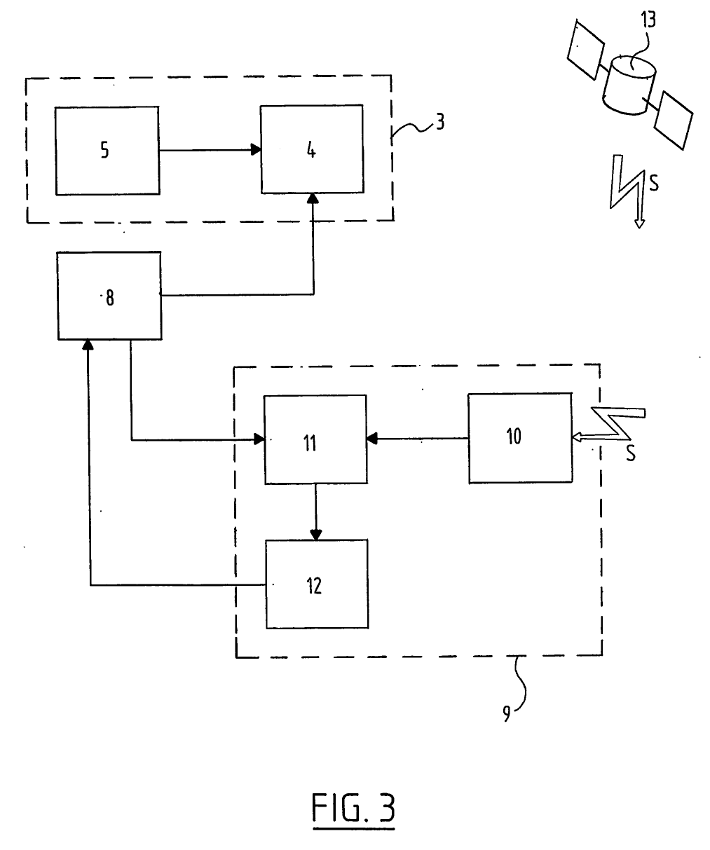

FIG. 3 is a schematic view of the different components of the systems of FIG. 1 and 2.

A stationary traffic monitoring system 1, here in the form of a red-light camera at an intersection 2, comprises means 3 for monitoring the traffic situation at intersection 2. These monitoring means 3 are formed by the actual camera 4 and by an induction loop 5 in the road surface, whereby camera 4 is activated when a vehicle 6 passes over the loop 5 while the traffic light 7 is red.

The traffic monitoring system 1 further comprises means for projecting data relating to the violation in a recording made by camera 4, such as the date and time of the recording, the already elapsed time of the red-light period, optionally the speed of vehicle 6, and so on. The record made by camera 4 can be assessed on the basis of these data and a ticket can be written to the holder of the registration of the photographed vehicle. The projection means are connected to a clock 8 which provides the date and time data.

In order to ensure that the data relating to the date and time are always shown correctly, clock 8 is connected to synchronizing means 9, whereby it is checked regularly and put right if necessary. Synchronizing means 9 comprise a receiver 10 with which a synchronization signal S is received, and a comparing element 11 in which synchronization signal S is compared to the time (and date) indicated by clock 8. The synchronizing means 9 are further provided with an adjusting or resetting element 12 whereby the clock 8 can be set to the time as indicated by synchronization signal S.

According to the invention synchronization signal S is transmitted from a satellite 13 which is at some distance above the surface of the earth. Compared to transmission from a transmitter mast disposed on the surface of the earth, this has the advantage that the signal can be transmitted over a greater distance, while the influence of atmospheric disturbances is moreover smaller. A good reception of synchronization signal S is hereby ensured in all conditions.

According to an embodiment of the invention which is recommended at this moment, satellite 13 is a navigation satellite which preferably forms part of the GPS system or the Galileo system. On the basis of the received synchronization signal S the location of the traffic monitoring system 1 can hereby also be determined or at least checked.

For a stationary system the determining of the location is of course not particularly important per se, although on the basis of the location the synchronization signal S can be used to set parameters specific to this location. The synchronization signal S can thus have different values for summer and winter time, wherein the location determines on which date the switch is made from the one value to the other. In addition, the system 1 could be switched off at determined times, for instance at night, on the basis of the location data, while it is also possible to set the speed limits differently subject to the time.

The location determination on the basis of synchronization signal S is particularly important for mobile traffic monitoring systems. An example of such a mobile system 101 is a mobile camera car which is provided with means 103 for monitoring the situation on a road 102. The monitoring means 103 can herein once again comprise a camera 104 which is activated by a radar trap 105 built into the front part of the car. This radar 105 measures the speed of other vehicles 106 on road 102. Means are also present here for projecting into records made by camera 104 of data concerning a detected traffic violation, generally exceeding of the maximum speed. These projection means are in turn connected to a clock 108 whereby a correct indication of the time and date of the violation can be recorded in the record.

In such a mobile traffic monitoring system 101 the synchronization signal S from satellite 13 can be used to display data about the location of a detected violation in the record. This is of great importance in providing conclusive proof. These location data may also be important for the later processing of the records made by camera 104, for instance in order to determine which court is responsible for imposing a sanction. Finally, the locally applicable maximum speed can always be entered correctly on the basis of the location data.

Although the invention is elucidated above on the basis of a number of embodiments, it is not limited thereto. Systems other than the described traffic monitoring systems could thus also make use of synchronization signals transmitted via a satellite. Systems for automatic toll collection can for instance be envisaged, wherein it is also important that the correct date and time of use of a particular road is indicated on the invoices sent to motorists. Nor is it necessary that only signals from a satellite are used for the synchronization. A combination of such signals with signals from a transmitter mast is likewise conceivable. Signals coming from different satellites can further be used. The scope of the invention is therefore defined solely by the following claims.

1. A method for synchronizing a clock of a traffic monitoring system, comprising of periodically transmitting a synchronization signal to the traffic monitoring system from a remote location, wherein said signal forms and indication of the exact time, comparing the time indicated by the clock with the synchronization signal, and adjusting the time indicated by the clock if different from the synchronization signal wherein the synchronization signal is transmitted from a satellite.

2. The method of claim 1, wherein said satellite is a navigation satellite and the location of the system is also determined from the received synchronization signal.

3. The method of claim 2, wherein the time derived from the received synchronization signal is adjusted to the location determined on the basis of the synchronization signal.

4. The method of claims through 3, wherein the operation of the traffic monitoring system is controlled on the basis of the time and/or location derived from the synchronization signal.

5. The method of claim 4, wherein a control signal is transmitted to the traffic monitoring system along with the synchronization signal.

6. A system for monitoring traffic comprising a traffic situation monitor, at least one clock connected to the traffic situation monitor and to a synchronizer, wherein the synchronizer is adapted to receive a synchronization signal, to compare the time indicated by the clock with said synchronization signal and to adjust the time indicated by the clock if different from the synchronization signal, wherein the synchronizer is adapted to receive the synchronization signal from a satellite.

7. The traffic monitoring system of claim 6, wherein said satellite is a navigation satellite, and the synchronizer is adapted to determine the location of the system from the received synchronization signal.

8. The traffic monitoring system of claim 7, wherein said synchronizer is adapted to adjust the time derived from the received synchronization signal to the location of the system as determined on the basis of the synchronization signal.

9. The traffic Traffic monitoring system according to claims 6 through 8 further comprising a controller which is connected to the synchronizer and which is adapted to control the operation of the traffic monitoring system on the basis of the time and/or location derived from the synchronization signal.

10. The traffic monitoring system according to claims 6 through 8 wherein the synchronizer is adapted to receive and pass on to the controller a control signal transmitted together with the synchronization signal.

11. The traffic monitoring system as according to claims 6 through 8 wherein the monitor is adapted to record the monitored traffic situation on the basis of a recording signal which is generated by the controller on the basis of a criterion, wherein the controller is adapted to adjust the criterion to the time and/or location, optionally on the basis of the control signal transmitted together with the synchronization signal.
